(19) United States
(12) Patent Application Publication
(10) Pub. No.: US 2008/0291318 A1
(43) Pub. Date: Nov. 27, 2008

(54) Method and Device for Identifying and Calibrating Panoramic Optical Systems

(75) Inventors: Jean-Claude ARTONNE, Montreal (CA); Mathieu VILLEGAS, Montreal (CA); Pierre KONEN, Montreal (CA); Simon THIBAULT, Saint-Foy (CA)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: 6115187 CANADA INC., Montreal (CA)

(21) Appl. No.: 12/135,545

(22) Filed: Jun. 9, 2008

Related U.S. Application Data
(63) Continuation of application No. PCT/IB2006/003738, filed on Nov. 27, 2006.

(30) Foreign Application Priority Data
Dec. 9, 2005 (FR) 05 12499

(51) Int. Cl. H04N 5/225

(52) U.S. Cl. 348/340; 348/E05.024

(57) ABSTRACT

A method for identifying a panoramic optical system enables its intrinsic characteristics to be semi-automatically or automatically determined so as to be able to subsequently apply the digital processes for appropriate corrections of the perspectives and distortions specific to the identified panoramic optical system. The panoramic optical system has a marking device visible from outside through a front lens, allowing identification by an operator, and/or a marking device directly projected on the image plane through the optical system, for automatic identification and calibration.

### CROSS-REFERENCE TO RELATED APPLICATIONS

This application is a Continuation of International Application No. PCT/IB2006/003738, filed Nov. 27, 2006, which was published in the French language on Oct. 4, 2007, under International Publication No. WO 2007/110697 A2 and the disclosure of which is incorporated herein by reference.

### BACKGROUND OF THE INVENTION

Embodiments of the present invention are directed to photography and video, and more particularly to the panoramic imagery.

The terms are as described below:

1. Panoramic optics: an optical system which can be dioptric and/or catadioptric (whether or not associating lenses and mirrors) generally with a field of view of more than 120 degrees. The panoramic optics themselves are divided into two main groups.

1.1 Very wide angle optics: a dioptric optical system composed generally of several lenses with a field of view (FOV) greater than 120 degrees. This group is subdivided into two types of optical systems defined below.
a. Fish-eye optics: very wide angle optics (generally greater than 160 degrees) and with axial symmetry, whose angular distribution function tends ideally to be constant.
b. Panomorph optics: a very wide angle optics with the possibility of greater and varied dissymmetry (anamorphosis) or variable angular distribution functions, or even a combination of both with the aim of increasing the resolution in the zones of interest and to optimize the area covered by the resulting image on the sensor.

1.2. Catadioptric optics: a system composed of one or more mirrors of varied shapes, whether or not integrated within the diopters, and whether or not associated with the additional group of lenses, offering an angle of view greater than 120 degrees.

2. Panoramic vision system: an assembly composed of a panoramic optical system, an image transmission system, and a digital processing system enabling restoration of perspectives by correcting the distortions resulting from panoramic optics.

3. Panoramic projection zone: the sensor zone (or of the image) on which the photographed or filmed environment is projected.

4. Adjacent projection zone: the unused sensor surface located around (generally in the case of panoramic optics) and/or at the center (specifically in case of catadioptric optics) of the panoramic projection zone.

Since the end of the 1990s, a certain number of technologies said to be “immersive” have been trying to enter the videoconference and video surveillance markets. The main advantage offered by a panoramic vision or immersive device, or at 360°, lies in the possibility for several users to see in several directions at the same time with only one video camera.

Nonetheless, in spite of this obvious advantage, the penetration of this type of technology remains marginal over the last 15 years.

This commercial difficulty results from several technical reasons, mainly from the lack of graphic resolution of panoramic video systems (partially solved today by the use of high resolution sensors and/or by the use of panomorphic optics). Additionally, the complexity of the methods for integrating immersive technologies in the existing infrastructures and systems has proved to be difficult.

This complexity is mainly due to the fact that the panoramic cameras (panoramic vision systems) must be calibrated one at a time by means of methods which are largely manual. Therefore they require qualified staff trained for this task.

In fact, a panoramic optics projects a space environment which is more or less hemispherical on a flat sensor (image plane) with very high distortion. It is thus necessary to know all the characteristics (calibration) in order to reshape and correct the perspectives of a part of the image by eliminating the distortions, and thus simulating a motor-driven video camera. The four main parameters for calibration of a panoramic optics are the following: (i) the type of distortion of the panoramic optics (function of distribution of pixels in space) and by extension, the shape of the image on the sensor (panoramic projection zone), (ii) the total angle of view of the panoramic optics, (iii) the position and the direction (in case of a panomorphic optics) of the image on the sensor, and (iv) the size of the image on the sensor.

If no information other than the projected image is available, determination of all of these characteristics is far from simple. Besides, the automatic detection or calibration algorithms can frequently generate errors.

To overcome these difficulties, most of the immersive technologies marketed today are proprietary solutions which have more or less the same angular distribution functions and the same angles of view. It is thus easier, if no compatibility with rival systems is desired, to define the default values in the software for the first two parameters presented above

On the other hand, the last two parameters depend on the positioning of the image sensor with respect to the objective. The last two parameters can thus vary largely from one camera to another, even if the cameras are built from the same components.

The manufacturers of panoramic systems have thus devised calibration methods which are mainly manual or semi-automatic, although some may be automatic, in spite of a high error rate in the latter. The automatic and semi-automatic methods enable generation of calibration and identification data, which must be associated with each camera and shared with each panoramic image processing or display system. The major drawback of this method is that it requires the work of a technician trained for this purpose.

That is why the manufacturers of panoramic vision systems have generally chosen to market integrated technologies, which do not consist of panoramic optics, but rather complete proprietary systems of panoramic vision (optics, camera and software). The calibration can thus be performed manually at the workshop. This solution tends to increase the cost of panoramic vision systems at the source. Further, this solution does not allow improving the existing camera population, which represents the largest market share.

It is desirable to allow efficient deployment and use of panoramic vision systems on a much larger camera population, without requiring costly staff interventions, or even systematically referencing each camera.

In particular, it is desirable to allow automatic determination of the four parameters presented above by an automatic or semi-automatic digital processing applicable to very wide angle optics.

Very wide angle or more restricted angle optics were not previously intended to be characterized by projection of any information on the image sensor, without this information being present in the field of view of the optics. In general, the information projection device is completely outside the optical system, even though it is integrated in a supporting or closely associated system.

Besides, a scene is commonly characterized, but not the optics. For example, U.S. Patent Application Publication No. 2005/0183273 describes a device which projects markings such as logos, reference marks, or the like on a scene and not on the sensor. These markings have varied utilities, such as performance of measurements, the marking of sport field limits or the projection of simple messages.

In U.S. Patent Application Publication No. 2003/0147594, markings are applied directly on the optical components with the aim of correct direction during the assembly of the complete optical system. These markings, if applicable, allow identification of a component, but in no case the complete system, and do not produce any additional information on the sensor in order to characterize the complete optical system.

The positioning of information directly in the sensor electronics is considered in U.S. Patent Application Publication No. 2004/0247120. A device is described which digitally adds visible or encrypted information to the images in such a way as to avoid alteration to the image perception for the human observer (commonly called “Watermark”). These devices, among others, give a protection against copying by placing a signature in the images.

Finally, there are a certain number of methods and devices which, as described in U.S. Patent Application Publication No. 2004/0144845, allow placing very specific marks directly on the objects, which can only be read by devices specially calibrated for this purpose.

### BRIEF SUMMARY OF THE INVENTION

An embodiment of the present invention comprises an optical system having an image sensor and a front lens projecting an image of a scene on the image sensor. A marking device introduces, into the optical system, at least a visible mark outside of the scene, the mark being visible in the image supplied by the image sensor at the same time as the scene.

According to one embodiment, the marking device is configured to project at least one mark on the image sensor, outside of the projection zone of the image of the scene on the image sensor.

According to one embodiment, the marking device includes a light source emitting light which is transmitted or reflected by at least one of the marks, in the visible and/or invisible spectrum, towards the image sensor.

According to one embodiment, at least one of the marks is a hologram.

According to one embodiment, at least one of the marks provides information on at least one of the optical system, a processing system, and a viewing system associated with the optical system.

According to one embodiment, the marking device is configured to introduce at least one mark through a surface of a lens, the surface being unused for the projection of an image on the image sensor, in such a way as to have the marks appear in the image supplied by the image sensor.

According to one embodiment, the unused surface through which the mark is introduced is located on the lateral side of the front lens.

According to one embodiment, the unused surface through which the mark is introduced is frosted.

According to one embodiment, the marking device is configured to introduce at least one mark in the neighborhood of a diaphragm of the optical system, in such a way as to have the marks appear in the image provided by the image sensor.

According to one embodiment, the marking device is configured to project at least one mark directly on the image sensor.

According to one embodiment, the marking device includes a light source and a mask forming at least one mark, by which the light rays produced by the light source are fed into the optical system and reach the image sensor.

According to one embodiment, the marking device includes a scattering member located between the light source and the mask.

According to one embodiment, the marking device includes a light guide to guide the light from the light source to the mask.

According to one embodiment, the marking device includes a reflecting surface to redirect the light from the light source to the mask.

According to one embodiment of the invention, the optical system includes a diaphragm through which rays from at least one of the marks pass and attain the image sensor.

According to one embodiment, the marking device includes an optical item of positive power to direct the light rays from at least one of the marks towards the image sensor.

According to one embodiment, the marking device includes a reflecting surface to direct the light rays coming from at least one of the marks towards the image sensor.

According to one embodiment, the marking device includes a diffractive item to direct the light rays from at least one of the marks towards the image sensor.

According to one embodiment, at least one of the marks is projected or applied on or near an intermediary image plane.

According to one embodiment, the optical system includes a mechanical alignment device to adjust the relative positions of the marking device, the optical system, and the image sensor.

According to one embodiment, the alignment device allows adjustment of the relative positions of the optical system with respect to the image sensor in a plane parallel to that of the image sensor, and/or adjusting the angular position of the optical system around the optical axis of the optical system, with respect to the image sensor.

According to one embodiment, the marking device introduces into the optical system at least one mark visible from outside the optical system.

According to one embodiment, at least one mark is introduced by the marking device into the optical system through a surface of the front lens, the surface being unused for the projection of the image of the scene on the image sensor, the mark being visible from outside the optical system through the front lens.

According to one embodiment, the mark, visible from outside the optical system through the front lens, is associated to a light source.

According to one embodiment, the light source is capable of emitting sufficient light through the front lens towards the outside to illuminate all or part of the scene observed by the optical system.

Another embodiment of the present invention is directed to a method of identifying an optical system projecting an image of a scene on an image sensor. The method includes introducing into the optical system at least one mark outside the scene, the mark being visible in the image provided by the image sensor at the same time as the scene. At least one mark is searched for in the image provided by the image sensor. At least one of the marks found is identified and the optical system is identified from the identified mark.

According to one embodiment, the marks are projected on the image sensor, outside of the projection zone of the image of the scene on the image sensor.

According to one embodiment, at least one of the marks is projected towards the image sensor by transmitting or reflecting the light emitted by a light source, in the visible and/or non visible spectrum.

According to one embodiment, the method further includes introducing at least one mark by one surface of a lens the surface being unused for the projection of an image on the image sensor, such that the marks appear in the image provided by the image sensor.

According to one embodiment, the surface of the lens through which the mark is introduced is located on one lateral side of a front lens.

According to one embodiment, the method further includes introducing at least one mark in the neighborhood of a diaphragm of the optical system, such that the marks appear in the image provided by the image sensor.

According to one embodiment, the method further includes projecting at least one mark directly on the image sensor.

According to one embodiment, the method further includes adjusting relative positions of the optical system, the image sensor, and a marking device introducing marks into the optical system.

According to one embodiment, the method further includes adjusting relative positions of the optical system with respect to the image sensor in a plane and/or an adjustment step for the angular position of the optical system around the optical axis of the optical system, with respect to the image sensor.

According to one embodiment, searching for and identifying the mark is carried out by a digital method.

According to one embodiment, at least one of the marks is a structured arrangement of geometrical shapes which together create a combination, encoding an item of information of identification.

According to one embodiment, searching for a mark in the image includes applying a digital processing of thresholding for separating colors of the image and/or detecting image zones having one characteristic specific to at least one mark.

According to one embodiment, searching a mark in the image includes applying a digital processing of pattern recognition for analyzing the intrinsic geometrical characteristics of shapes detected in the image and/or comparing the detected shapes to a reference shape.

According to one embodiment, at least one of the marks is configured to characterize the optical properties of the optical system.

According to one embodiment, at least one of the marks is configured to characterize the properties or state of operation of a system of a panoramic vision system, including the optical system.

According to one embodiment, at least one of the marks is configured to characterize a range or a family of optical systems.

According to one embodiment, the method further includes analyzing a position and/or a direction and/or dimensions of at least one mark identified to determine, by comparison or calculation, a position and/or a direction of the image of the scene projected on the image sensor.

According to one embodiment, the method further includes analyzing a position and/or a direction and/or dimensions of at least one mark identified to determine, by comparison or calculation, an outline of the image of the scene projected on the image sensor.

According to one embodiment, the method further includes determining an outline of the image of the scene projected on the image sensor by applying at least one iteration of an outline detection algorithm.

According to one embodiment, the method further includes associating information collected by the identification of marks and/or information on a panoramic vision system including the optical system, to a computer file or temporary or permanent variables.

According to one embodiment, the method further includes introducing or selecting data, by an operator, from at least one mark.

According to one embodiment, the method further includes introducing at least one mark in the optical system such that the mark is visible from outside of the optical system.

According to one embodiment, the method further includes introducing at least one mark for each surface of a front lens, the surfaces being unused for the projection of the image of the scene on the image sensor, the mark being visible from outside the optical system through the front lens.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a lateral view of a very wide angle optical system, fitted with a marking device according to one embodiment of the present invention;

FIGS. 2a and 2b are views of one part of the optical system represented on FIG. 1, illustrating variants of the marking device;

FIG. 3 is a lateral view of a very wide angle optical system, fitted with a marking device according to another embodiment of the present invention;

FIGS. 4a and 4b are views of one part of the optical system represented on FIG. 3, illustrating variants of the marking device;

FIG. 5 schematically represents a very wide angle optical system in perspective fitted with several marking devices according to an embodiment of the present invention;

FIG. 6 represents an alignment device in perspective according to an embodiment of the present invention, enabling adjustment of the relative position of the optical system with respect to the sensor;

FIGS. 7a to 7d represent examples of marking according to an embodiment of the present invention;

FIG. 8 illustrates the steps of an optical system identification method, according to an embodiment of the present invention;

FIG. 9 illustrates the steps of an automatic calibration method of a panoramic optics, according to an embodiment of the present invention; and

FIG. 10 is a perspective view of rear three quarter of a front lens of an optical system with very wide angle, associated with a marking according to another embodiment of the present invention.

### DETAILED DESCRIPTION OF THE INVENTION

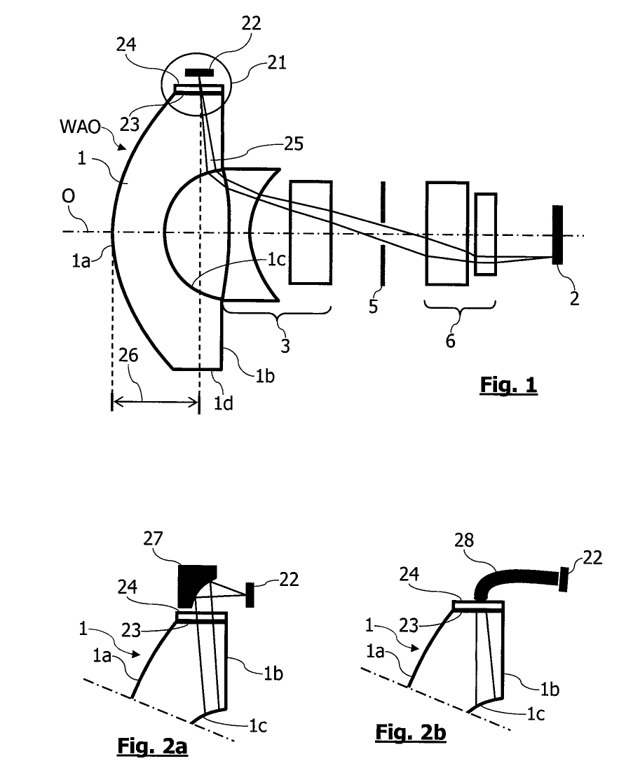

FIG. 1 shows a very wide angle optical (WAO) system. The optical system includes a front lens 1 with a very wide angle, an image sensor 2, a set of front lenses 3 comprising, for example, one negative lens placed against the front lens 1 and a positive lens placed between the negative lens and a diaphragm 5, and a set of rear lenses 6 placed between the diaphragm 5 and the image sensor 2. The front lens 1 includes a front face 1a, a rear plane face 1b surrounding a largely hemispheric central cavity 1c, and a lateral cylindrical face 1d located between the front face 1a and the rear face 1b.

According to one embodiment of the present invention, the WAO optic system includes a marking device 21. The marking device 21 introduces one or more marks (visual information) in the optical system in such a way that the latter will be visible in the image generated by the image sensor 2. Such marks are introduced into one or more locations in the WAO optical system such that a mark does not obscure part of the image of the scene.

Depending on the characteristics of the optical system, a sufficient location is provided for insertion of the marking device 21. Thus, the mark produced by the marking device 21 is introduced by a side of a lens of the optical system, and/or in an autonomous way just before the image sensor 2. Several distinct marking devices 21 can be provided in the same optical system to transmit information or various marks or from various sources. The marks represent one or more logos, codes, symbols, letters, digits, or any other sign.

In FIG. 1, one or more marks are introduced in the optical system by an optical surface of the front lens 1, which is distinct from the outer face 1a. The selected surface for the marks is not used for projection of an image of the scene observed on the image sensor. In the example of FIG. 1, this unused surface is located on a lateral face of the lens 1. In fact, in very wide angle optics, the general characteristics of the front lens 1 allow entry of light rays through the lateral face 1d. This choice is preferred in most cases, since it is the simplest and least expensive solution to implement. A better quality image of the mark is also obtained on the image sensor, due to the benefits from all of the corrections and focusing, provided by the whole optical system, to the light rays coming from the observed scene.

According to one embodiment, a light source 22 such as a light emitting diode (LED) is placed at a certain distance from the side face 1d of the front lens 1. A mask 23 containing the mark may be placed on or proximate to the lateral face 1d of the front lens 1. The mask 23 may be in direct contact with the lateral face 1d or may be located at a certain distance between the lateral face 1d and the light source 22. The lateral face 1d of the front lens 1 can be frosted to scatter the light. In this case, the mask 23 is formed on or is located against the lateral face 1d of the front lens 1, or otherwise is located proximate to the lateral face 1d. According to one embodiment, a scattering member 24 can also be placed in contact with the mask 23. The scattering member 24 is then placed between the mask 23 and the light source 22.

The assembly comprising the light source 22, the scattering member 24, and the mask 23 forms a transmitter assembly 21. A certain quantity of light produced by the transmitter assembly 21 is transmitted into the front lens 1 through the lateral face 1d. This quantity of light forms a narrow light beam 25, which is directed through the lens 1 towards the interior of the WAO optic system. The narrow light beam 25 corresponds to a light acceptance cone defined by the characteristics of the entrance aperture (pupil) of the optical system. The size of the cone is defined by the size of the diaphragm 5. Only the light rays of the cone passing through the diaphragm 5 are considered to be useful for marking. The light rays, after having passed through diaphragm 5, are focused by the lens group 6 on the image sensor 2 to produce an image of the mark formed by the mask 23.

The position of the emitter assembly 21 on the lateral face 1d of the front lens 1 determines the image position of the mark on the sensitive surface (image plane) of the image sensor 2. The image of the mark on the image sensor is located outside of the projection zone of the panoramic image of the observed scene formed on the image sensor 2. More specifically, the image position of the mark on the sensitive surface of the image sensor 2 is defined as a function of the angular position with respect to the optical axis O of the optic system, and of the distance between the latter and the emitter assembly 21, and as a function of the direction of the image sensor 2. The exact position of the mark on the image sensor 2 can be determined with the help of an optical design software or by any other means of calculation, or by empirical methods.

It should be noted that a certain quantity of light produced by the emitter assembly 21 can be found on the outside of the light cone 25. This quantity of light, known as “spurious light,” propagates freely in the front lens 1. The use of an antireflection coating on the front face 1a and rear face 1b of the front lens 1 reduces the spurious light generated by reflections and/or refractions on the front face 1a and rear face 1b of the front lens, which could reach the image sensor 2. This spurious light can produce “ghost” images of the mask in the projection zone of the panoramic image and in the adjacent projection zone, on the sensitive surface of the image sensor 2. The effect of the spurious light on the image sensor 2 can be attenuated or eliminated by dynamically adjusting the intensity of the emitter assembly 21, to make the “ghost” images undetectable by the image sensor or to prevent the “ghost” images from affecting the quality of the panoramic images provided by the image sensor 2.

According to another embodiment illustrated by FIG. 2a, the light from the source 22 is redirected towards the scattering member 24, then the mask 23, through a light reflecting surface 27. According to still another embodiment illustrated by FIG. 2b, the light coming the source 22 is directed towards the scattering member 24, then the mask 23 through one or more light guides 28.

Of course, the marking device 21 can also introduce marks on the image sensor 2 through another lens of the WAO optical system than the front lens 1. As in the example of FIG. 1, the mark is introduced through a surface of the lens not used for projection of an image of the observed scene on the image sensor.

FIG. 3 shows another embodiment of the present invention, wherein the WAO optical system includes a marking device located behind or around diaphragm 5. The marking device includes a light emitter assembly 21 such as that described in FIG. 1. Thus, the light emitter assembly 21 includes a light source 22 such as an LED, and a mask containing a mark 23, placed in contact with or proximate to the light source 22.

In a preferred embodiment, a scattering member 24 can also be placed in contact with the mask 23, between the mask 23 and the light source 22. An optical item of positive optical power 35, such as a positive lens, is placed in such a manner as to produce an image of the mask at infinity or at a conjugated position of the image sensor 2. This conjugated position is determined by the rear group of lenses 6 of the optical system. The ideal position of the mask 23 is located exactly at the focal point of the optical item 35.

The optical item 35 provides a quasi-collimated light which is then redirected towards the group of lenses 6 by a fold-back mirror 36. The direction of the mirror defines the angle of projection γ of the quasi-collimated incident light 37 on the group of lenses 6. The light thus directed towards the group of lenses 6 is focused in the image plane of the sensitive surface plane of the image sensor 2.

The position PM of the image of the mark can thus be estimated as a first approximation with respect to the center of the sensor 2 or optical axis O of the optical system in the following way:

PM=EFL(N)×γ (1)

where EFL (N) is the focal length of the rear group of lenses 6. The position PM is adjusted in order to guarantee that the image of the mark is on the sensitive surface of the image sensor 2, outside of the projection zone of the panoramic scene observed through the WAO optical system. It must be noted that the mirror 36 can be replaced by a diffractive optical item.

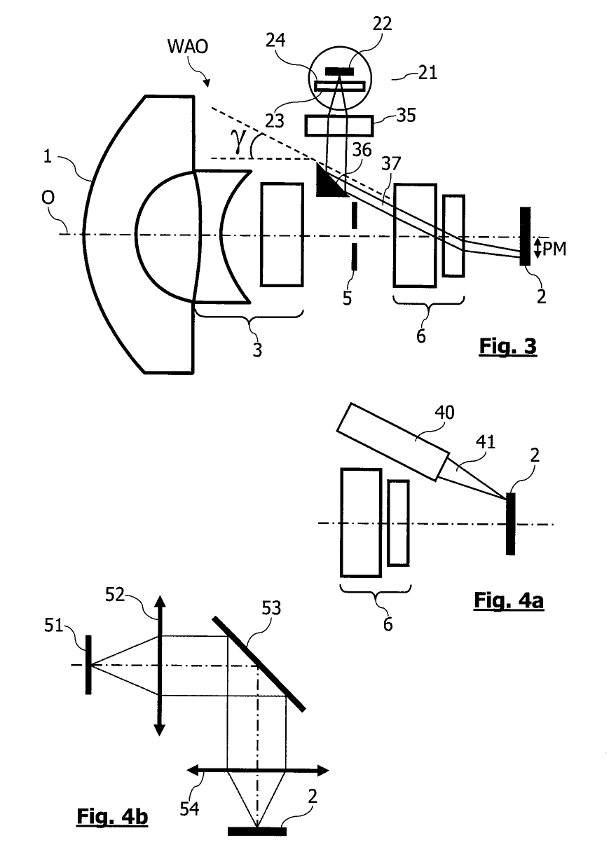

In another embodiment illustrated by FIGS. 4a, 4b, it is also possible to include between the last lenses 6 and the image sensor 2 a marking device, which may be integral or not with the optical system. The marking device includes, as necessary, one or more fold-back mirrors and one or more lenses for focusing one or more marks in a determined position of the sensitive surface of the image sensor 2. For example, FIG. 4a, the marking device 40 includes an emitter assembly 21 as described above, which directly projects one or more marks on the sensitive surface (image plane) of the image sensor 2. For this purpose, the marking device 40 can include an optical assembly having one or more lenses, ensuring the optical conjugation of the mask and the image sensor 2. The marking device 40 can also includes one or more fold-back mirrors. The marking device 40 is placed and directed in order to guarantee that the image of the mark is located on the sensitive surface of the image sensor 2, outside of the projection zone of the panoramic image of the scene observed by the WAO optical system.

According to one embodiment illustrated by FIG. 4b, the marking device is located behind the WAO optical system so that the image produced by the optical system coincides with an intermediate image plane 51. The mark is preferably placed or projected on or proximate to the image plane 51.

According to one preferred embodiment, the marking device includes an optical relay consisting of one or more lenses 52, 54 and as required, one or more fold-back mirrors 53, to transfer the WAO optical system image formed in the intermediate image plane 51 towards the sensitive surface of the sensor 2. The lenses 52, 54, which schematically represent an optical relay, may be replaced by any optical device enabling transfer of the image of the intemmediate image plane 51 to the sensitive surface of the sensor 2. The magnification factor produced by the optical relay is preferably in absolute value to prevent any loss of resolution.

In the embodiment described above, the light source 22 may or may not be monochromatic and may or may not be coherent. Thus, it may be a laser source. The light is produced by the light source 22 can alternatively come from the ambient lighting of the scene, which is transmitted, for example by reflection, to the mask 23.

According to one embodiment, the mark comprises one or more reflecting materials illuminated by the light source 22. In this case, it is not necessary to provide a mask 23. Alternatively, the mark is composed of one or more light emitting materials. In this case, it is not necessary to provide a light source 22 and a mask 23. According to another embodiment, the mark is produced by a hologram. In this case, the hologram contains the mark, making the mask 23 and the scattering member 24 unnecessary. The hologram can be of the reflection or transmission type.

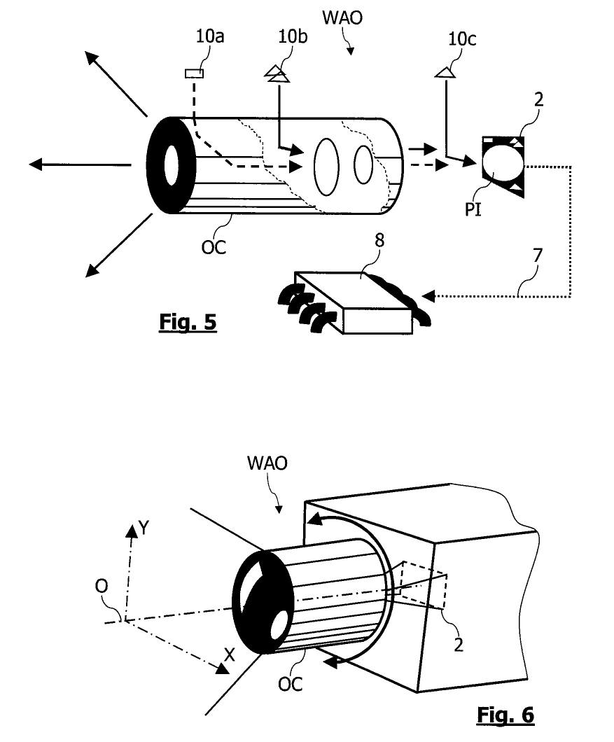

FIG. 5 represents a very wide angle optical WAO system coupled with a transmission system 7, to a digital processing system 8. The WAO system comprises an objective OC such as those represented on the FIGS. 1 and 3 and an image sensor 2 connected to a digital processing system 8. The WAO optical system includes one or more of the marking devices described above in combination. Thus, a mark 10a is introduced in the objective by the lateral face of the front lens. A mark 10b is introduced in the neighborhood of the diaphragm of the objective, and a mark 10c is directly transmitted on the sensitive surface of the sensor 2. All the marks are introduced into the optical system so that they appear on the sensitive surface of the sensor 2 outside the projection zone of the panoramic image PI.

According to one embodiment, an internal mechanical device of the WAO optical system is provided for aligning the marking device and all of the optical components of the optical system with the image sensor 2. For example, the mechanical device can comprise grooves, mistake-proofing members and/or other items. Such a mechanical device is advisable when the WAO optical system is not totally symmetrical by revolution and has an anamorphose, as in the case of panomorphic optical systems.

Thus, as in FIG. 6, a mechanical device is provided to adjust the position and direction of the whole image (marks and projected image of the observed scene) on the sensitive surface of the image sensor 2. The mechanical device may or may not integral with the WAO optical system, and adds to any other usual adjustment such as the adjustment of the optical system focus point. To be more precise, the mechanical device allows adjusting the position of the image in the image plane along two distinct axes X and Y, and in rotation around the optical axis 0.

Such an adjustment device is of real interest, since in general, the only adjustment devices along the axes X and Y do not act at the objective (optical system), but only at the image sensor or its support, or otherwise on all or part of the camera internal device. Besides, adjustment of the angular position of the optical components around the optical axis 0 is not generally provided on the cameras.

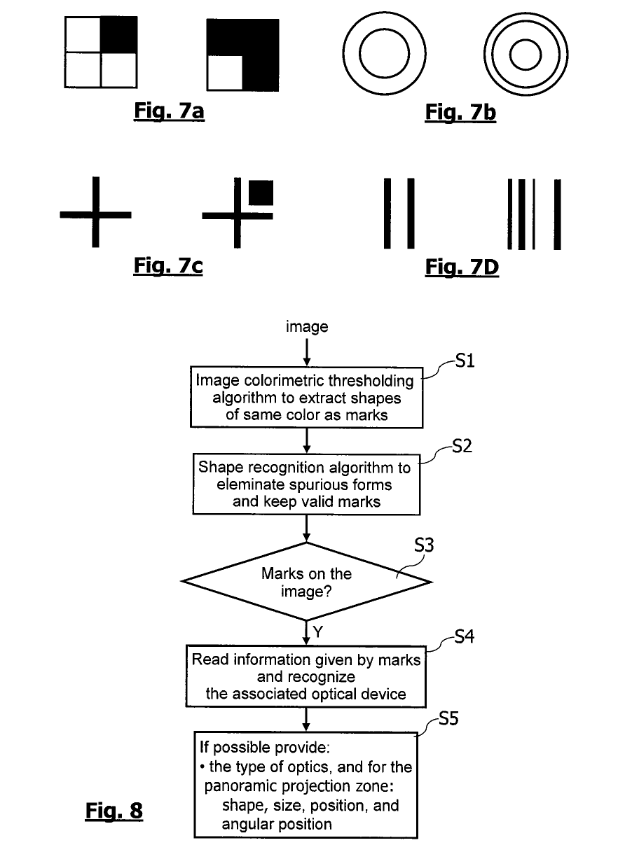

FIGS. 7a through 7d represent a few examples of marks used for marking an optical system. Thus, the marks projected on sensor 2 can be of different shapes and represent different symbols or drawings such as squares (FIG. 7a), circles (FIG. 7b), crosses (FIG. 7c), lines (FIG. 7d), digits, letters, or the like. The marks are advantageously composed of simple geometrical symbols originating from ordered sequences, encoding identification information. The marks of each sequence may be combinations of a limited number of different geometrical forms, each combination encoding one item of identification information. Thus, in FIG. 7a, each mark includes a combination of black and/or white squares of identical dimensions. In FIG. 7b, the marks include a variable number of concentric circles. In FIG. 7c, the marks include a combination of a black cross and black or white squares. In FIG. 7d, the marks include bar codes.

It should be noted that the use of ordered sequences of simple geometric symbols offers the advantage of allowing a binary definition of the information and multiplying the number of possible combinations. Such sequences of symbols also offer the advantage of being simpler to be recognized by a digital system and more resistant to noise, interferences, and disturbances potentially generated by the optical system or the destructive digital compression systems, generally used for the transport of video contents. The recognition of these marks, or of targeted parts thereof, enables characterizing and identifying the optical system and determining whether it is referenced or known by a digital processing system or associated display.

The marks projected on the image sensor 2 outside of the projection zone of the image of the scene observed by the WAO optical system are analyzed and recognized with various algorithms according to various embodiments. A representation of these algorithms in the form of a flowchart is shown in FIG. 8.

At step S1, the image is first processed digitally in order to separate the marks present in the image from the rest of the image. This operation is performed, for example, by algorithms known as calorimetric thresholding, to separate certain relevant colors if the type of mark sought is characterized by specific colors. Such marks are simpler to separate if they are located in a restricted chromatic range. For example, if the marks are red, the colorimetric thresholding algorithm allows extracting all the red shapes contained in the image.

At step S2, an algorithm known as shape recognition is applied to the image resulting from calorimetric thresholding processing, i.e., consisting only of shapes previously extracted by thresholding. This step determines if a mark is present in the image, and if this mark is valid according to a cross-reference table. For example, if the image is supposed to contain square shaped marks (such as those represented in FIG. 7a), then the characteristics (dimensions, direction, position) of all of the squares of the image are extracted from the image.

At step S3, if the valid marks (corresponding to the required shapes) have been detected in the image, step S4 is executed. Otherwise the identification method ends without providing characterization information of the optical system.

At step S4, the valid marks are analyzed to determine the characterization and identification information of the optical system. This identification operation can be performed by extracting one or more items of identification information of each mark by using a table providing cross-references between the information liable to be extracted from the marks with the information characterizing the optical system. The analysis of the marks includes, for example, translating each mark considered as an optical code (such as a bar code) into optical system identification information.

The characterization information comprises four main calibration parameters of a panoramic optics mentioned above, i.e., a type of optical system, as well as the information concerning the panoramic projection zone in the image, to know its position, its angular position, its shape and its dimensions. This cross-reference table can be stored in a database within the associated digital processing system, or be a remote table.

All of the marks introduced in the optical system, can include a certain number of characteristic marks common to one type or one given family of optical systems and known by the associated digital system, as well as the marks ensuring precise identification of the optical system model. Of course, in the case of specialized panoramic vision system which uses only one very specific optical system and which consequently does not require to be distinguished from other similar optical systems, it is not indispensable to provide marks which allow precise identification of the optical system model.

The identification of the optical system enables, notably in the case of panoramic optical systems, determination of adequate projection functions to rectify the distortions generated by the panoramic optics. The identification of the optical system can also be used as protection against copying (projection of logos or trademarks on the sensor). It can also be useful to follow up and to geographically monitor the marketing of the system, to manage the privileged rights on certain proprietary optical systems. According to one embodiment, the digital system can thus authorize or prohibit the use or access to the image.

Once the recognition of the optical system has been successfully performed, the marks can be used to determine the position, the size, and the angular position of the image PI projected on the sensitive surface of the image sensor 2. According to one embodiment, the marks are positioned and arranged geometrically with respect to the panoramic projection zone PI on the image, in such a way as to serve as dimensional and space reference systems.

By comparison of the characteristics (position, direction, and size) of the marks in the image provided by the sensor 2 with the reference marks, the digital processing system 8 determines the characteristics of the panoramic projection zone (shape, dimensions, position, angular position). From these characteristics, the digital system determines the geometrical transformation operations to be applied to the image to obtain an image in which the distortions introduced by the panoramic optics have been at least partially eliminated. The characteristics of the panoramic projection zone, as well as the information relating to the projection functions, allowing correcting the distortions, if any, of the panoramic image and restoring the perspectives of the observed scene, can be stored in a database accessible to the processing system 8.

The characteristics of the panoramic projection zone or any other zone of the image determined with the help of the marks can be used as approximation, with the view of performing a more precise determination of these characteristics. In fact, it is possible that the alignment relating to the marks and the panoramic projection zone is not perfect. The presence and the detection of the marks allow determining the limits of the search field in the image provided by the sensor, and thus avoiding the errors and/or reducing the processing time.

In this case, an additional processing can be implemented by the processing system 8 to detect the outline of the panoramic projection zone. This process illustrated in FIG. 9 includes the steps S11 to S14. At step S11, an optional pre-processing can be applied to the image provided by the sensor. This pre-processing includes for example, an outline determination of the image to eliminate the spurious pixels that hinder the correct detection of the panoramic projection zone.

At step S12, the processing identifies the panoramic projection zone PI and provides indications of size, position, and direction of this zone in the image by using the characteristics of this zone drawn from the marks. For example, if the panoramic projection zone PI has an elliptical or circular shape, Hough's transformation (algorithm known in the image analysis) applied to the image enables identifying the PI zone and gives indications of size, direction, and position of the PI zone in the image. At step S13, if the results obtained show sufficient precision, the characteristics obtained are used to determine the operations of geometrical transformation to be applied to the images (step S14). On the contrary, if the results obtained by the automatic calibration are not sufficiently precise, step S12 is performed again using the characteristics obtained during the previous performance. In the case of an unsatisfactory result, the errors can be corrected or compensated manually in order to allow the digital device to recalculate the shape and the position of the panoramic projection zone PI taking into account the corrections. If the results are not conclusive, a method to allow determining manually the outlines of the panoramic projection zone can be provided. All of the information thus gathered constitute the optical system calibration data.

This patent application also aims at protecting, in an independent manner, a marking device using the marks visible from outside of the objective through the front lens 1. It is obvious that such a marking device can be used independently of any other marking device, in particular, those described earlier.

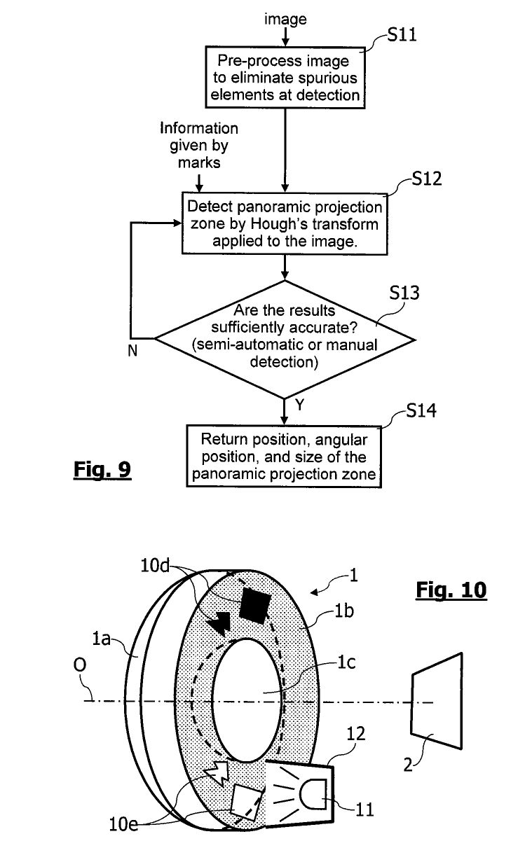

FIG. 10 shows the front lens 1 of a very wide angle optical system. The front lens 1 presents a front face 1a and a rear face 1b which can be planar, surrounding a more less hemispheric central cavity 1c. The image sensor 2 is generally disposed on the optical axis 0 of the front lens in such a way that lens 1 combined with other lenses of the objective (not shown) forms an image on the sensitive surface of the image sensor 2.

In general, the rear face 1b of the front lens is not used for the image transmission. Usually, this face 1b is made opaque and/or darkened to limit the possible intrusion of spurious light rays in the optical system. Such an unused zone appears in the rear face of the front lens in most of the optical systems, whether with a very wide angle or with a narrower field of view.

According to one embodiment, one or more marks are placed on or near the unused surfaces of the front lens of the optical system. Thus, in FIG. 10, one or more marks 10d, 10e are placed on the rear face 1b of lens 1. The marks are made on the materials that can be seen with or without illumination through the front face 1a of the front lens 1. Thus, the marks can be visible to the naked eye or with appropriate equipment where they appear only in the frequencies located outside of the color spectrum visible for man, or for holograms.

According to one embodiment, the unused surfaces around the marks are covered by a material that absorbs the light in order to obtain greater contrast. According to another embodiment one or more light sources 11 can be placed behind the marks in order to improve their visibility. Thus, in the example of FIG. 1, the marks 10e are performed by locally removing the layer that makes the rear face 1b partially or totally opaque, to allow the light to pass through the marks. By an appropriate control of the light sources, the marks 10e can provide information on the operating state of the optical system or of the panoramic vision system assembly. The light sources may emit in the spectrum of visible colors. These light sources preferably include LEDs, which are arranged at the rear of the rear face 1b of the front lens 1, on the inside of the optical system. The light sources thus project the light to the exterior of the front lens 1 and therefore of the optical system, passing through the front lens 1a.

The light emitted through the marks 10e to the interior of the front lens 1 then propagates to the front face 1a. At this interface, the light is subjected to refraction as well as a reflection. The light rays transmitted by refraction are then found at the exterior of the lens 1. These light rays are therefore visible from the outside of the optical system.

Preferably, the surface of the front face 1a of the front lens 1 is covered by an antireflection coating which maximizes the transmission at the interface and minimizes the reflection. If the light scattered outside is sufficiently powerful, it can also be used to illuminate the scene observed by the optical system. The wavelength or the spectral band of the illumination can be selected to enhance identification and/or the marking of the optical system by appropriate devices (for example infrared vision system), and/or produce a specific illumination.

A certain quantity of light can nevertheless reach the image sensor 2 by reflection, then by transmission and produce a “ghost image” in the panoramic vision zone or on any other surface of the sensor, in the case of non panoramic optics. The intensity of the light source 11 is therefore chosen preferably to avoid this phenomenon, or at least, to be imperceptible by the image sensor 2. According to one embodiment, the light sources 11 are focused and directed to limit the spurious reflections on the image sensor 2. A masking device 12, for example, can also be provided, which has the shape of a truncated cone or casing, ensuring an optical separation at the back of the light source from the rest of the optical system.

The WAO optical system includes a combination of one or more marking devices described above. Thus, the rear face 1b of the front lens 1 of the OC objective includes marks 10d, 10e, and marks 10a, 10b, 10c are entered at various points of the objective in such a way to be projected on the sensitive surface of the sensor 2, as described before in reference to FIG. 5. A semi-automatic or manual calibration is required when the identification marks of the optical system are found only on the rear face 1b of the front lens 1, and therefore are not projected on the image sensor. In such a case, an operator must, in fact, provide the digital processing system with the optical system identification information. On the basis of such information, the digital system determines the geometrical characteristics of the panoramic projection zone (step S12). These items of information added to the information relating to the profile of the optical system distortion allow calibration of the optical system. These items of information can be stored and associated to the identification information of the camera, in a database, to be then redistributed or used directly by the digital processing device 8.

Contrary to the “fish-eyes” objectives, the panomorphic optics, as well as the catadioptric optics can have angular distribution functions and very varied shapes of the panoramic projection zone. It is therefore impossible to determine, without identifying beforehand the exact type of the optical system, mathematical formula of which must be implemented to correct the distortions. Only external and complex measurement or calibration devices enable obtaining the information necessary for the correction.

With the help of a marking device of the type which introduces a mark on the image sensor (FIGS. 1-5), it is possible to identify the panoramic optical system. Once identified, it is possible to determine the adequate correction of the distortion, if the type of optical system is known to the processing system 8. This marking device allows identification that can be made entirely automatically with a digital analysis of the image produced on the sensor.

This type of marking device also enables determining the panoramic image positioning on the image sensor. In fact, a panoramic optics produces a panoramic image which generally does not occupy the whole of the sensor. In order to correct the distortion with the help of a digital device, it is important to know precisely the position, direction, and the size relating to the panoramic image to be able to adequately apply the digital functions for correction of distortions. The digital processing methods enable determining the position, the size, the shape, and the direction of the panoramic image. However, these methods often generate serious errors or even a total malfunctioning if the shape of the panoramic image outline is altered by the light artifacts (like a dazzling causing an iridescence on the parts of the image outline) and/or by the presence of very low luminosity along the border of the image.

With the help of a marking device of this type, one or more specific marks are projected on the image sensor through the optical system. These marks allow identification of the panoramic optical system. These marks with known relative dimensions and positions can then be used for dimensional identification to estimate or determine precisely the position, direction, and size of the image and thus to correctly apply the distortion correction formulas.

This type of marking device allows performing an automatic calibration by a processing or display system, without having to access an individual calibration database of the cameras. In fact, a panoramic optics produces an image which is affected by distortions. In order to correct these distortions digitally, a manual or semi-automatic calibration step of the panoramic view system is performed. This operation is mainly performed only during the installation of the device and often remains complex. It should be generally carried out by a technician trained for this purpose. The calibration information thus generated is stored in a file then shared with the various display software. This necessarily implies that the display software should have access, in addition to the image produced by the camera, to the database related to the camera containing these individual parameters of calibration. This renders the software architecture and the communication protocols complex and limits considerably the possibility of interoperability thus making nearly impossible the continuous calibration of panoramic optics on-the-fly by the display systems having access only to the video flow.

On the contrary, with the type of marking device projecting marks on the image sensor, the digital system can digitally and automatically identify the referenced panoramic optical system and thus apply the adequate distortion correction without it being necessary to use to a database containing all the individual parameters of the camera.

With a marking device of the type producing marks visible from outside the optical system (FIG. 10), it is possible to visually identify the optics simply by looking through the front lens from outside the system. Even if the marking device is built into a support masking the information generally written on the optical system case, the marks placed on the rear face 1b of the front lens 1 always remain visible. The optical system can thus be identified, and for a referenced optical model, it is possible to determine semi-automatically the appropriate distortion correction. These two types of marking devices can be used jointly to determine the distortion profile.

It will be obvious for one skilled in the art that embodiments of the present invention have diverse variants of performance and applications. In particular, such embodiments do not apply necessarily to a panoramic optical system but to any optical system providing digital images.

Although this is not desirable, the marks can also be introduced in the optical system in such a way as to appear in the panoramic image projection zone in the images provided by the sensor. In this case, even the faces of a lens of the optical system, useful for the projection of an image of the scene on the image sensor, can be used to project the marks on the image sensor. The adverse effect of such marks may be temporary only if these marks are produced by a light source which can be deactivated, for example, by a manual control, or activated only during an initialization phase of the panoramic vision system. Concerning this matter, it must be noted that the presence of the marks are only for purposes of performing identification and calibration of the optical system. Once these operations have been performed, the marks can be “switched off” by an appropriate control of the light sources.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An optical system comprising:
an image sensor;
a front lens projecting an image of a scene onto the image sensor; and
a marking device introducing into the optical system at least one mark outside of the scene, the at least one mark being visible in the image provided by the image sensor at the same time as the scene.

2. The optical system according to claim 1, wherein the marking device is configured to project at least one mark on the image sensor, outside of a zone for projection of the image of the scene on the image sensor.

3. The optical system according to claim 1, wherein the marking device includes a light source emitting light which is transmitted or reflected by at least one of the marks, in at least one of the visible spectrum and the non-visible spectrum, towards the image sensor

4. The optical system according to claim 1, wherein at least one of the marks is a hologram.

5. The optical system according to claim 1, wherein at least one of the marks provides information on at least one of an operating state, the optical system, and at least one of a processing and a display system associated with the optical system.

6. The optical system according to claim 1, wherein the marking device is configured to introduce at least one mark through a surface of a lens, the surface being unused for the projection of an image on the image sensor, such that the marks appear in the image provided by the image sensor.

7. The optical system according to claim 6, wherein the unused surface by which the mark is introduced is located on a lateral face of a front lens.

8. The optical system according to claim 6, wherein the unused surface by which the mark is introduced is frosted.

9. The optical system according to claim 1, wherein the marking device is configured to introduce at least one mark in the neighborhood of a diaphragm of the optical system, such that the mark appears in the image supplied by the image sensor.

10. The optical system according to claim 1, wherein the marking device is configured to project at least one mark directly on to the image sensor.

11. The optical system according to claim 1, wherein the marking device includes a light source and a mask forming at least one mark, wherein light rays produced by the light source are introduced into the optical system and reach the image sensor.

12. The optical system according to claim 11, wherein the marking device includes a scattering member located between the light source and the mask.

13. The optical system according to claim 11, wherein the marking device includes a light guide to guide light coming from the light source towards the mask.

14. The optical system according to claim 11, wherein the marking device includes a reflecting surface to redirect light coming from the light source towards the mask.

15. The optical system according to claim 1, further comprising:
a diaphragm through which light rays coming from at least one of the marks pass and reach the image sensor.

16. The optical system according to claim 1, wherein the marking device includes an optical item of positive power to direct light rays from at least one of the marks towards the image sensor.

17. The optical system according to claim 16, wherein the optical item of positive power is a positive lens.

18. The optical system according to claim 1, wherein the marking device includes a reflecting surface to direct light rays from at least one of the marks towards the image sensor.

19. The optical system according to claim 1, wherein the marking device includes a diffractive item to direct light rays coming from at least one of the marks towards the image sensor.

20. The optical system according to claim 1, wherein at least one of the marks is projected onto an intermediate image plane.

21. The optical system according to claim 1, further comprising:
a mechanical alignment device to adjust relative positions of at least one of the marking device, the optical system, and the image sensor.

22. The optical system according to claim 21, wherein the alignment device is configured to at least one of adjust a relative position of the optical system with respect to the image sensor in a plane parallel to that of the image sensor, and adjust the angular position of the optical system around an optical axis of the optical system, with respect to the image sensor.

23. The optical system according to claim 1, wherein the marking device introduces into the optical system at least one mark visible from outside of the optical system.

24. The optical system according to claim 1, wherein at least one mark is introduced by the marking device in the optical system through a surface of the front lens, the surface being unused for the projection of the image of the scene on the image sensor, the mark being visible from the outside of the optical system through the front lens.

25. The optical system according to claim 24, wherein the mark visible from outside of the optical system through the front lens is at least partially formed by a light source.

26. The optical system according to claim 25, wherein the light source is configured to emit light through the front lens towards the outside to illuminate at least part of the scene observed through the optical system.

27. A method of identifying an optical system projecting an image of a scene onto an image sensor, the method comprising:
introducing into the optical system at least one mark outside of the scene, the mark being visible in the image supplied by the image sensor at the same time as the scene;
searching for at least one mark in the image supplied by the image sensor;
identifying at least one of the marks found; and
identifying the optical system from the identified mark.

28. The method according to claim 27, wherein the marks are projected on the image sensor, outside of an image projection zone of the scene on the image sensor.

29. The method according to claim 27, wherein at least one of the marks is projected towards the image sensor by transmitting or reflecting light emitted by a light source, in at least one of the visible spectrum and the non-visible spectrum.

30. The method according to claim 27, further comprising:
introducing at least one mark through one surface of a lens the surface being unused for the projection of an image on the image sensor, such that the marks appear in the image supplied by the image sensor.

31. The method according to claim 30, wherein the surface of the lens through which the mark is introduced is located on a lateral face of a front lens.

32. The method according to claim 27, further comprising:
introducing at least one mark in the neighborhood of a diaphragm of the optical system, such that the mark appears on the image supplied by the image sensor.

33. The method according to claim 27, further comprising:
projecting at least one mark directly onto the image sensor.

34. The method according to claim 27, further comprising:
adjusting relative positions of at least one of the optical system, the image sensor, and a marking device introducing marks in the optical system.

35. The method according to claim 27, further comprising:
at least one of adjusting relative positions of the optical system with respect to the image sensor in a plane, and adjusting an angular position of the optical system around the optical axis of the optical system, with respect to the image sensor.

36. The method according to claim 27, wherein at least one of searching and identifying is performed by a digital method.

37. The method according to claim 27, wherein at least one of the marks is a structured arrangement of geometrical shapes which together form a combination encoding an item of identification information.

38. The method according to claim 27, wherein searching for a mark in the image includes at least one of applying a digital thresholding processing to separate certain colors of the image, and identifying image zones having one characteristic specific to at least one mark.

39. The method according to claim 27, wherein searching for a mark in the image includes at least one of applying a digital processing for shape recognition analyzing the intrinsic geometrical characteristics of shapes detected in the image, and comparing the shapes detected with a reference shape.

40. The method according to claim 27, wherein at least one of the marks is associated with characterizing information of optical properties of the optical system.

41. The method according to claim 27, wherein at least one of the marks represents characterizing information of at least one of the properties and the operating state of a panoramic view system comprising the optical system.

42. The method according to claim 27, wherein at least one of the marks represents a characterizing information of at lest one of a range and a family of optical systems.

43. The method according to claim 27, further comprising:
analyzing at least one of a position, a direction, and dimensions of at least one identified mark to determine, by comparison or calculation, at least one of a position and a direction of the projected image of the scene on the image sensor.

44. The method according to claim 27, further comprising:
analyzing at least one of a position, a direction, dimensions of at least one identified mark to determine, by comparison or calculation, an outline of the projected image of the scene on the image sensor.

45. The method according to claim 27, further comprising:
determining an outline of the projected image of the scene on the image sensor by application of at least one iteration of an outline detection algorithm.

46. The method according to claim 27, further comprising:
associating at least one of information collected by the identification of marks, and information on a panoramic vision system comprising the optical system, with at least one of a computer file, temporary variables and permanent variables.

47. The method according to claim 27, further comprising:
at least one of introducing and or selecting data by an operator, from at least one mark.

48. The method according to claim 27, further comprising:
introducing at least one mark in the optical system such that the mark is visible from outside of the optical system.

49. The method according to claim 27, further comprising:
introducing at least one mark through a surface of a front lens, the surface being unused for the projection of the image of the scene on the image sensor, the mark being visible from the outside of the optical system through the front lens.
